(19) United States
(12) Patent Application Publication
(10) Pub. No.: US 2026/0214096 A1
(43) Pub. Date: Jul. 23, 2026

(54) DETERMINING A PACKET'S NETWORK PATH

(71) Applicant: Lenovo Global Technology (United States) Inc., Morrisville, NC (US)

(72) Inventors: George-Andrei Stanescu, Ilfov (RO); Fred Allison Bower, III, Durham, NC (US); Vlad Marian Spoiala, Bucharest (RO); Eduard Pavel, Constanta (RO)

(21) Appl. No.: 19/029,087

(22) Filed: Jan. 17, 2025

(51) Int. Cl. H04L 9/40

(52) U.S. Cl. CPC H04L 63/101; H04L 63/0236; H04L 63/20

(57) ABSTRACT

A method for tracing a packet stream in a network using access control lists includes deriving an access control list (“ACL”) for a packet stream being analyzed. The ACL includes a source address, a destination address, and enables an ACL hit counter. The method includes installing the ACL on each node of a plurality of nodes of a network between a computing device with the source address and a computing device with the destination address. An ACL hit counter of a node increases for each packet of the packet stream that passes through the node and matches the ACL. The method includes monitoring the ACL hit counters for the plurality of nodes over an interval of time, and analyzing a number of hits of each ACL hit counter of the nodes to identify nodes of the plurality of nodes where the packet stream passed.

### FIELD

The subject matter disclosed herein relates to computer network analysis and more particularly relates to determining a packet's network path.

### BACKGROUND

Network debugging is difficult when having to deal with large networks, multiple data packet streams and/or multiple network protocols. A network administrator might be under the impression that the data packet streams and associated packets are routed and/or forwarded on a certain path when that is not the case. A visual depiction of how a packet or a stream travel in a network can significantly help a human understand where the problem might be. Existing methods for determining the path that a packet takes through the network are either unreliable, not applicable to certain network devices, not scalable or require additional hardware.

### BRIEF SUMMARY

A method for tracing a packet stream in a network using access control lists is disclosed. An apparatus and system also perform the functions of the method. The method includes deriving an access control list (“ACL”) for a packet stream being analyzed. The ACL includes a source address, a destination address, and enables an ACL hit counter. The method includes installing the ACL on each node of a plurality of nodes of a network between a computing device with the source address and a computing device with the destination address. An ACL hit counter of a node of the plurality of nodes increases for each packet of the packet stream that passes through the node and matches the ACL. The method includes monitoring the ACL hit counters for the plurality of nodes over an interval of time, and analyzing a number of hits of each ACL hit counter of the nodes to identify nodes of the plurality of nodes where the packet stream passed.

An apparatus for tracing a packet stream in a network using access control lists includes a processor and non-transitory computer readable storage media storing code. The code is executable by the processor to perform operations that include deriving an access control list (“ACL”) for a packet stream being analyzed. The ACL includes a source address, a destination address, and enables an ACL hit counter. The operations include installing the ACL on each node of a plurality of nodes of a network between a computing device with the source address and a computing device with the destination address. An ACL hit counter of a node of the plurality of nodes increases for each packet of the packet stream that passes through the node and matches the ACL. The operations include monitoring the ACL hit counters for the plurality of nodes over an interval of time, and analyzing a number of hits of each ACL hit counter of the nodes to identify nodes of the plurality of nodes where the packet stream passed.

A system for tracing a packet stream in a network using access control lists includes a plurality of nodes of a network and a network controller. The network controller includes a processor and non-transitory computer readable storage media storing code. The code is executable by the processor to perform operations that include deriving an ACL for a packet stream being analyzed. The ACL includes a source address, a destination address, and enables an ACL hit counter. The operations include installing the ACL on each node of the plurality of nodes of the network between a computing device with the source address and a computing device with the destination address. An ACL hit counter of a node of the plurality of nodes increases for each packet of the packet stream that passes through the node and matches the ACL. The operations include monitoring the ACL hit counters for the plurality of nodes over an interval of time, and analyzing a number of hits of each ACL hit counter of the nodes to identify nodes of the plurality of nodes where the packet stream passed.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a network diagram with a network controller that includes a tracing apparatus for tracing a packet stream in a network using access control lists, according to various embodiments;

FIG. 2 is a schematic block diagram illustrating an apparatus for tracing a packet stream in a network using access control lists, according to various embodiments;

FIG. 3A is a table with contents of an access control list (“ACL”) for use with a “continue” action, according to various embodiments;

FIG. 3B is a table with contents of ACLs of a node, according to various embodiments;

FIG. 3C is a table with contents of the ACLs of FIG. 3B with the addition of a packet tracker ACL with a same action as an ACL with the same source and/or destination host, according to various embodiments;

FIG. 3D is a table with contents of the ACLs of FIG. 3B with the addition of a different packet tracker ACL with a same action as an ACL with the same source and destination host, according to various embodiments;

FIG. 3E is a table with contents of the ACLs of FIG. 3C with an additional ACL and a modified packet tracking ACL based on the additional ACL, according to various embodiments;

FIG. 4 matches a printout of a portion of an ACL of a node, according to various embodiments;

FIG. 5 is a schematic block diagram illustrating another apparatus for tracing a packet stream in a network using access control lists, according to various embodiments;

FIG. 6 is a schematic flow chart diagram illustrating a method for tracing a packet stream in a network using access control lists, according to various embodiments; and

FIG. 7 is a schematic flow chart diagram illustrating another method for tracing a packet stream in a network using access control lists, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

A method for tracing a packet stream in a network using access control lists is disclosed. An apparatus and system also perform the functions of the method. The method includes deriving an access control list (“ACL”) for a packet stream being analyzed. The ACL includes a source address, a destination address, and enables an ACL hit counter. The method includes installing the ACL on each node of a plurality of nodes of a network between a computing device with the source address and a computing device with the destination address. An ACL hit counter of a node of the plurality of nodes increases for each packet of the packet stream that passes through the node and matches the ACL. The method includes monitoring the ACL hit counters for the plurality of nodes over an interval of time, and analyzing a number of hits of each ACL hit counter of the nodes to identify nodes of the plurality of nodes where the packet stream passed.

In some embodiments, the method includes overlaying a visual packet travel path on a visual network diagram that includes the nodes of the network, the source computing device, and the destination computing device. The visual packet travel path intersects the identified nodes where the packet stream passed. In other embodiments, the method includes deriving the network diagram. In other embodiments, deriving the network diagram comprises using network information from a neighboring network protocol.

In some embodiments, the method includes replacing the source address with a new source address in the ACL of gateway nodes of the plurality of nodes replacing a source address with a new source address by way of network address translation (“NAT”) and/or nodes of the plurality of nodes downstream of the gateway nodes. In other embodiments, the source address includes a source media access control (“MAC”) address and/or a source internet protocol (“IP”) address and the destination address includes a destination MAC address and/or a destination IP address. In other embodiments, the ACL includes an action compatible with other ACLs installed at the plurality of nodes.

In some embodiments, the network is a private network and the packet stream travels from the private network to a public network and back to the private network. The ACL is installed on the nodes of the private network. In other embodiments, the ACL includes a protocol type, an action, and/or an enablement of the ACL hit counter. In other embodiments, the ACL is for an ingress port of a node and/or an egress port of the node.

An apparatus for tracing a packet stream in a network using access control lists includes a processor and non-transitory computer readable storage media storing code. The code is executable by the processor to perform operations that include deriving an access control list (“ACL”) for a packet stream being analyzed. The ACL includes a source address, a destination address, and enables an ACL hit counter. The operations include installing the ACL on each node of a plurality of nodes of a network between a computing device with the source address and a computing device with the destination address. An ACL hit counter of a node of the plurality of nodes increases for each packet of the packet stream that passes through the node and matches the ACL. The operations include monitoring the ACL hit counters for the plurality of nodes over an interval of time, and analyzing a number of hits of each ACL hit counter of the nodes to identify nodes of the plurality of nodes where the packet stream passed.

In some embodiments, the operations further include overlaying a visual packet travel path on a visual network diagram that includes the nodes of the network and/or the source computing device and the destination computing device. The visual packet travel path intersects the identified nodes where the packet stream passed. In other embodiments, operations further include deriving the network diagram using network information from Link Layer Discovery Protocol (“LLDP”) and/or Cisco Discovery Protocol (“CDP”). In other embodiments, the operations further include replacing the source address with a new source address in the ACL of gateway nodes of the plurality of nodes replacing a source address with a new source address by way of network address translation (“NAT”) and/or nodes of the plurality of nodes downstream of the gateway nodes.

In some embodiments, the source address includes a source MAC address and/or a source IP address and the destination address includes a destination MAC address and/or a destination IP address. In other embodiments, the processor is part of a network controller in communication with each of the plurality of nodes of the network. In other embodiments, the network is a private network and the packet stream travels from the private network to a public network and back to the private network. The ACL is installed on the nodes of the private network. In other embodiments, each node of the plurality of nodes includes one of a switch and a router. In other embodiments, the ACL is for an ingress port of a node and/or an egress port of the node.

A system for tracing a packet stream in a network using access control lists includes a plurality of nodes of a network and a network controller. The network controller includes a processor and non-transitory computer readable storage media storing code. The code is executable by the processor to perform operations that include deriving an ACL for a packet stream being analyzed. The ACL includes a source address, a destination address, and enables an ACL hit counter. The operations include installing the ACL on each node of the plurality of nodes of the network between a computing device with the source address and a computing device with the destination address. An ACL hit counter of a node of the plurality of nodes increases for each packet of the packet stream that passes through the node and matches the ACL. The operations include monitoring the ACL hit counters for the plurality of nodes over an interval of time, and analyzing a number of hits of each ACL hit counter of the nodes to identify nodes of the plurality of nodes where the packet stream passed.

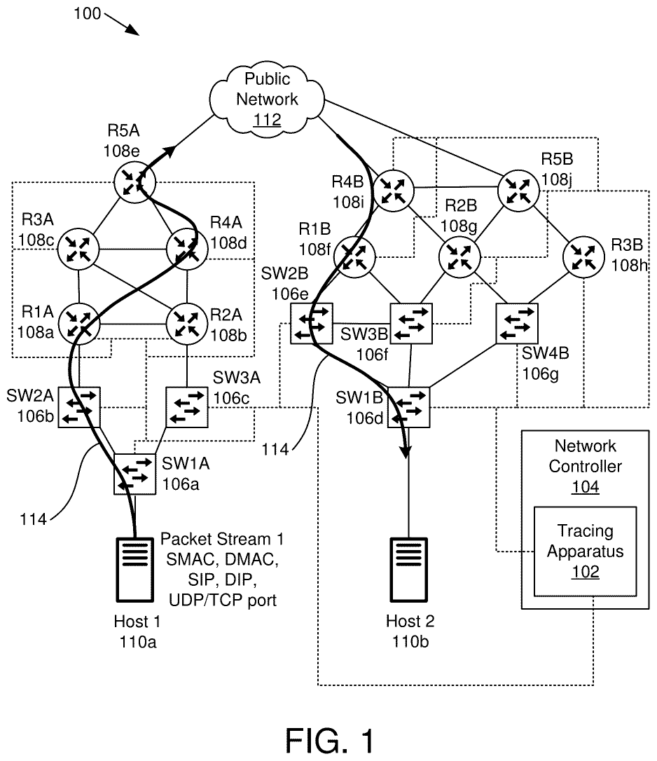

FIG. 1 is a schematic block diagram illustrating a network diagram 100 with a network controller 104 that includes a tracing apparatus 102 for tracing a packet stream in a network using access control lists, according to various embodiments. The network diagram 100 includes a tracing apparatus 102 in a network controller 104 that is in communication with each node of the network (except for nodes of the public network 112). The tracing apparatus 102 allows a user to derive an access control list (“ACL”) for a packet stream being analyzed (see Packet Stream 1 on FIG. 1) where the ACL includes a source address, a destination address, and that enables an ACL hit counter. The tracing apparatus 102 installs the ACL on each node of the network between a computing device with the source address, which is host 1 110a in FIG. 1, and a computing device with the destination address, which is host 2 110b in FIG. 1. An ACL hit counter of a node of the network increases for each packet of the packet stream that passes through the node and matches the ACL. The tracing apparatus 102 monitors the ACL hit counters over an interval of time and analyzes a number of hits of each ACL hit counter of the nodes to identify nodes of the network where the packet stream passed. Once the nodes where the packet stream passed are known, the tracing apparatus 102, in some embodiments, overlays a visual packet travel path 114 on a visual network diagram over the nodes where the packet stream passed.

The network controller 104, in various embodiments, is in communication with each node of the network and is able to send commands to the nodes and is able to receive information from the nodes. The connections between the network controller 104 and the nodes are the dashed lines in FIG. 1. The nodes of the network are divided into a left portion connected between host 1 110a and the public network 112 and a right portion connected between host 2 110b and the public network 112. The left portion includes nodes in the form of switches SW1A 106a, SW2A 106b, and SW3A 106c along with routers R1A 108a, R2A 108b, R3A 108c, R4A 108d, and R5A 108e. The right portion of the network includes nodes in the form of switches SW1B 106d, SW2B 106e, SW3B 106f, and SW4B 106g along with routers R1B 108f, R2B 108g, R3B 108h, R4B 108i, and R5B 108j. The public network 112, in some embodiments, includes the internet and includes numerous nodes typically out of the control of the network controller 104.

Host 1 110a and host 2 110b, in various embodiments, are computing devices in a datacenter, at an edge computing location, in a home, in an office, or other location. Host 1 110a and host 2 110b, in various embodiments, are rack-mounted servers, desktop computers, laptops, tablet computers, mainframe computers, workstations, and the like or any combination thereof. While two hosts are depicted, in other embodiments the network includes additional hosts.

In the depicted embodiment of FIG. 1, host 1 110a transmits a packet stream to Host 2 110b, which is called Packet Stream 1. The packet stream includes a source MAC (“SMAC”) address, a destination MAC (“DMAC”) address, a source IP (“SIP”) address, and a destination IP (“DIP”) address. Packet Stream 1 in FIG. 1 also includes user datagram protocol (“UDP”)/transmission control protocol (“TCP”) port, which defines which UDP or TCP port the packet stream exits from Host 1 110a. Some well known ports are 21, which is a file transfer protocol (“FTP”) port, port 11, which is a secure shell (“SSH”) port, port 80, which is a hypertext transfer protocol (“HTTP”) port, and port 443, which is a secure HTTP (“HTTPS”) port.

Where there is a gateway within the network that uses network address translation (“NAT”), the ACLs upstream and including the gateway would include a source address from the perspective of the source host (e.g., Host 1 110a). The ACL is changed to reflect a new source address downstream of the gateway. The new source address, in some embodiments, matches an IP address or other address assigned to the gateway node. Where a packet traveling through a network encounters a gateway before arriving at a destination host, the ACLs may also have to be changed for downstream nodes between the gateway and the destination address to reflect a new source address used between the gateway and the destination address. In some embodiments, the gateway replaces a private source address with a public source address. In other embodiments, the gateway separates parts of a private network with a different subnet mask. For example, if SW2A 106b and SW3A 106c are gateways, packets traversing from SW1A 106a to either SW2A 106b or SW3A 106c will have the source address replaced with a different source address. The tracing apparatus 102 changes the source address for all nodes downstream of the gateway with the different source address. In the network of FIG. 1, nodes downstream of SW2A 106b and SW3A 106c will receive an ACL from the tracing apparatus 102 with the different source address.

Note that the nodes of the network connected to the network controller 104 may be part of a LAN, a WAN, a fiber network, a wireless network, or the like and may include any combination thereof. In addition to the switches SW1A-SW3A 106a-c, SW1B-SW4B 106d-g and routers R1A-R5A 108a-e, R1B-R5B 108f-j, the network includes cables, fiber optics, and/or other network equipment. The wireless network includes one or more wireless connections. The lines connecting the nodes, which are the switches and routers of the network, are one possible configuration. In other embodiments, the network includes more or less nodes with different connections.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM®”), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA®”). Alternatively, the wireless connection may be a cellular telephone network communication. All standards and/or connection types include the latest version and revision of the standard and/or connection type as of the filing date of this application.

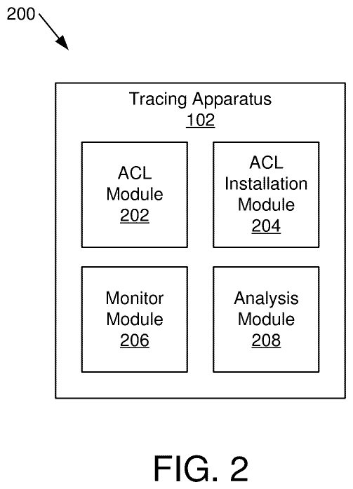

FIG. 2 is a schematic block diagram illustrating an apparatus 200 for tracing a packet stream in a network using access control lists, according to various embodiments. The apparatus 200 includes a tracing apparatus 102 with an ACL module 202, an ACL installation module 204, a monitor module 206, and an analysis module 208, which are described below. In some embodiments, the apparatus 200 is implemented using executable code stored on non-transitory computer readable media. In other embodiments, all or a portion of the apparatus 200 is implemented using a programmable hardware device and/or hardware circuits.

The apparatus 200 includes an ACL module 202 configured to derive an ACL for a packet stream being analyzed. The ACL includes a source address, a destination address, and enables an ACL hit counter. The source address is from the computing device sending the packet stream. In FIG. 1, Host 1 110a is the source and so the source address would be the source MAC address and/or the source IP address of Host 1 110a. The destination address is for the computing device intended to receive the packet stream. In FIG. 1, the destination computing device is Host 2, 110b. The destination address is the destination MAC address and/or the destination IP address of Host 2 110b. Nodes include ingress ports and egress ports. In some embodiments, the ACL is formulated for the ingress ports. In other embodiments, the ACL is formulated for egress ports.

The ACL also includes an instruction to enable an ACL hit counter for packets coming from the source address and going to the destination address. The ACL hit counter will increase each time a packet from the packet stream goes through the node with the ACL where the packet has the source address and the destination address. In some embodiments, the ACL module 202 includes a protocol type, such as UDP or TCP in the ACL.

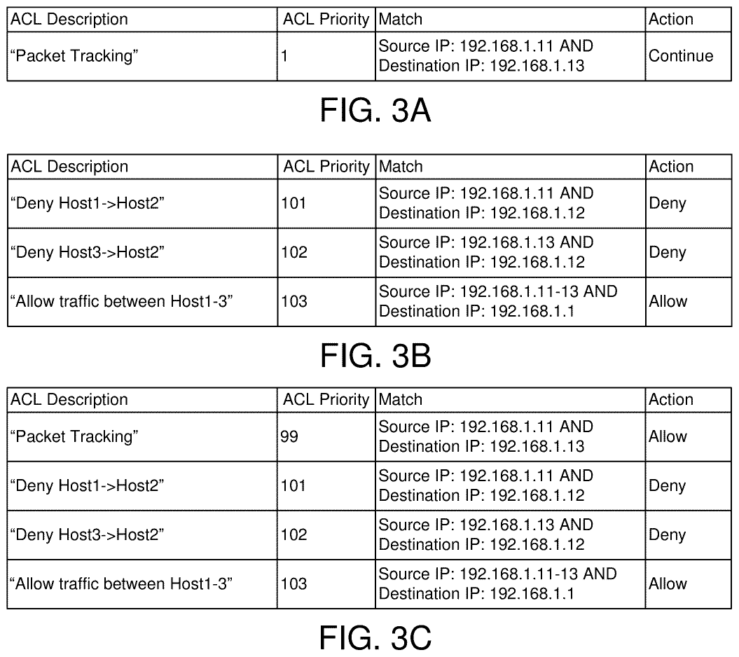

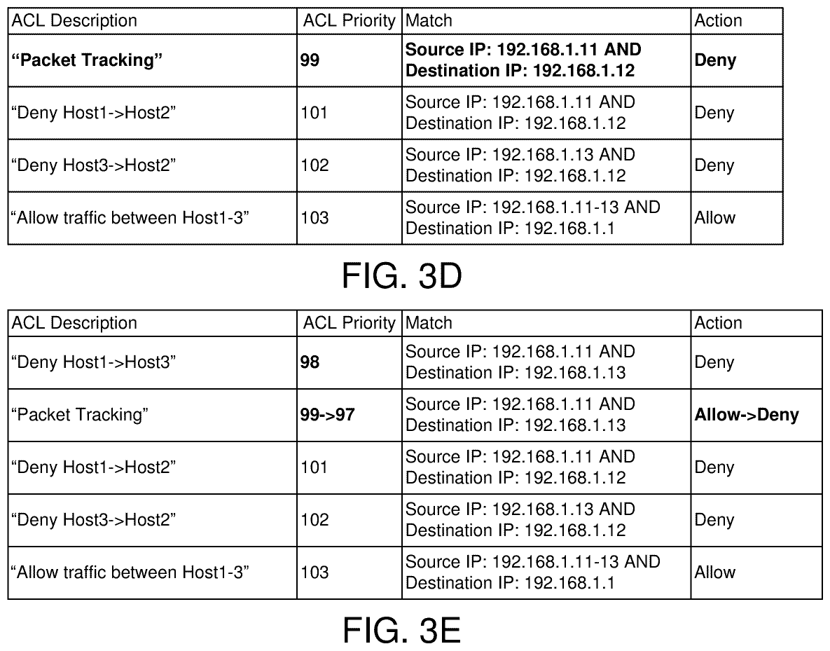

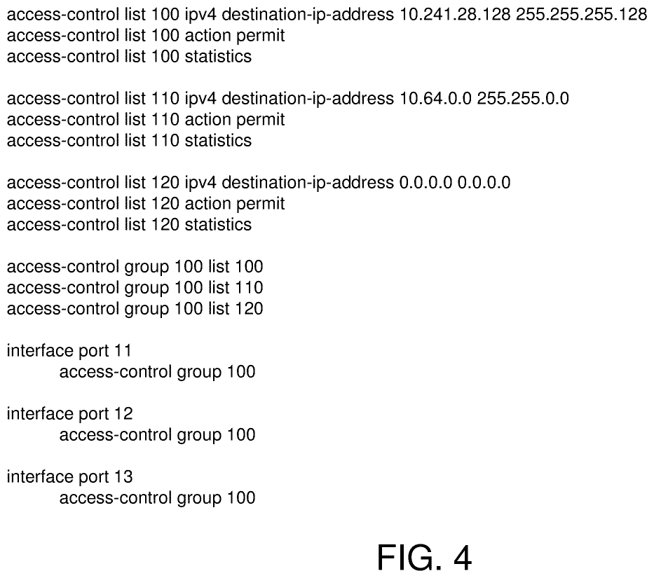

In some embodiments, the ACL module 202 adds to the ACL an action. The action is compatible with actions from ACLs at the node involving the source address or the destination address. FIG. 3A is a table with contents of an ACL for use with a “continue” action, according to various embodiments. In some embodiments, the actions of the ACLs are modified to include a “continue” action, which enables the user to create an ACL that will not have to match other actions of other ACLs at a node. The “continue” action is intended to merely enable an ACL hit counter or other action without having to also add “allow” or “deny” actions. While “allow” and “deny” are used in the examples of FIGS. 3B-3E, other ACLs include other actions or actions with different names that do the same as allow and deny.

In cases without this “continue” action, the ACL module 202 and/or the user creates an ACL that does not conflict with other ACLs of a node. FIG. 3B is a table with some contents of ACLs of a node, according to various embodiments. In the example of FIG. 3B, the node include three ACLs. The first ACL with a description of “Deny Host1->Host2” is an ACL designed to deny traffic coming from Host1 and going to Host2 from passing through the node. Note that for the examples related to FIGS. 3B-3E, the names of the hosts do not correspond with the network diagram 100 of FIG. 1. The first ACL has an ACL priority of 101 and includes the source IP address of Host1 and the destination IP address of Host2 with an action of “deny.” Thus, packets coming from Host1 and destined for Host2 will be dropped at the node.

The second ACL in FIG. 3B has an ACL description of “Deny Host3->Host2” with an ACL priority of 102 and includes a source IP address matching Host3 and a destination IP address matching Host2 with an action of “deny.” Thus, packets coming from Host3 and destined for Host2 will be dropped at the node. The third ACL has an ACL Description of “Allow traffic between Host1-3” with an ACL priority of 103 and a source IP address matching Host1, Host2, and Host3 and a generic destination IP address and an action of “allow.” Packets coming from any of Host1, Host2, and Host3 are allowed to pass regardless of their destination. However, the previous ACLs with an ACL priority of 101 and 102 have a higher priority so they override the third ACL with an ACL priority of 103. A packet coming from Host1 and going to Host3 is allowed while a packet coming from Host1 and going to Host2 is not allowed based on the priorities.

FIG. 3C is a table with contents of the ACLs of FIG. 3B with the addition of a packet tracker ACL with a same action as an ACL with the same source and destination host, according to various embodiments. The first line of the table includes an ACL created by the ACL module 202 with an ACL description of “Packet Tracking,” an ACL priority of 99, a source IP address of Host1 and a destination IP address of Host 3 and an action of “allow.” This ACL matches the allow action of the “Allow traffic between Host1-3,” which has an “allow” action so the Packet Tracking ACL needs to have an action of “allow” to not conflict with the “Allow traffic between Host1-3” ACL.

FIG. 3D is a table with contents of the ACLs of FIG. 3B with the addition of a different packet tracker ACL with a same action as an ACL with the same source and destination host, according to various embodiments. In this example, the packet is going from Host1 to Host2 so the ACL must match the “Deny Host1->Host2” ACL, which has an action of “deny.” Thus, the “Packet Tracking” ACL also has a “deny” action for this node to not interfere with the existing ACL of this node. While this particular node has a “deny” action for packets going from Host1 to Host2, other nodes may not have this action so that the packet stream being analyzed may traverse the network in a different path than through this node.

FIG. 3E is a table with contents of the ACLs of FIG. 3C with an additional ACL and a modified packet tracking ACL based on the additional ACL, according to various embodiments. The first line of the table includes the new ACL, which has an ACL description of “Deny Host1->Host3” and an ACL priority of 98 with a source IP address matching Host1 and a destination IP address matching Host3 and an action of “deny.” The previous “Packet Tracking” ACL had an action of “allow,” which now conflicts with the new ACL. To remedy this problem, the “allow” of the Packet Tracking ACL is changed to “deny” and the ACL priority is changed to 97 to have a higher priority than the new ACL. The ACL module 202 and/or a user changes the Packet Tracking ACL as depicted in FIG. 3E in response to the new ACL. The ACL module 202 and/or a user repeats the same process for each node to have an appropriate action that does not interfere with other ACLs of the node.

Reading an ACL by the ACL module 202 and/or a user, in some embodiments, includes use of an application that reads information of a node. Three example ACLs are depicted in FIG. 4, which replicates a printout of a portion of an ACL of a node. The example in FIG. 4 is one possible ACL representative of ACLs. The embodiments described herein are applicable to other ACLs. The first three lines define an ACL 100, which is defined as internet protocol version 4 (“ipv4”) and only defines a destination IP address. Note that the destination IP address includes a subnet mask of 255.255.255.128. The action is in the second line, which is “permit,” which may be the same as “allow” in the examples of FIGS. 3B-3E. The third line turns on “statistics” for traffic going to the destination IP address. The next three lines define an ACL 110, which is the same as ACL 100 except with a different destination IP address. The next three lines define ACL 120 and have a destination IP address IP address of 0.0.0.0 0.0.0.0, which is a generic IP address and applies to all destinations.

The next three lines group ACL 100, ACL 110, and ACL 120 into an ACL group 100. The next two lines define the interface at port 11, which implements ACL group 100. The same is done for interface port 12 and interface port 13. Other ACLs include other actions, commands, formats, etc. One of skill in the art will recognize ACL forms and formats for the ACL module 202 and/or a user to read.

The apparatus 200 includes an ACL installation module 204 configured to install the ACL on each node of a plurality of nodes of a network between a computing device with the source address and a computing device with the destination address. After installation of the ACL, an ACL hit counter of a node of the plurality of nodes increases for each packet of the packet stream that passes through the node and matches the ACL. In some embodiments, the ACL installation module 204 installs the ACL from the ACL module 202 on every node in the network. While installing the ACL on a node of the network, the ACL module 202 and/or a user modify the ACL to be compatible with other ACLs of the node, as described in relation to FIGS. 3A-3E. The ACL installation module 204 installs the ACL on all nodes in communication with the network controller 104, but not on other nodes that are part of the public network 112.

The apparatus 200 includes a monitor module 206 configured to monitor ACL hit counters for the plurality of nodes over an interval of time. In some embodiments, a user will select an interval of time, such as 10 seconds. In other embodiments, the monitor module 206 selects a pre-programmed interval of time. The monitor module 206 accesses the ACL hit counter(s) of each node in the network and retrieves a hit count for the time interval. For example, where the interval of time is 10 seconds, the monitor module 206 selects from a first time to a second time where the difference between the first time and the second time is 10 seconds and retrieves the hits from each ACL hit counter in each node between the first time and the second time. In some embodiments, the monitor module 206 times the interval of time to coincide with the packet stream transmitting packets.

In some embodiments, the monitor module 206 enables the ACL hit counters to operate for the interval of time and monitors the ACL hit counters of the nodes of the network during the interval of time. In other embodiments, the ACL hit counters collect hits for a period of time and store hits and the monitor module 206 accesses the storage with the hits and selects hits within a first time and a second time spanning the interval of time. In other embodiments, coordinates with Host 1 110a to determine when the packet stream (e.g. Packet Stream 1) is to be transmitted and selects the time interval during a time when the packet stream is intended to be transmitted. One of skill in the art will recognize other ways to monitor the ACL hit counters of the nodes of the network for a selected interval of time.

The apparatus 200 includes an analysis module 208 configured to analyze a number of hits of each ACL hit counter of the nodes to identify nodes of the plurality of nodes where the packet stream passed. Where an ACL hit counter registers hits, the analysis module 208 identifies the node of the ACL hit counter as a node where the packet stream passed. The analysis module 208, in some embodiments, reviews the ACL hit counters for each node in the network. In cases where some ACL hit counters register hits that are many less than other nodes, in some embodiments, the analysis module 208 does not identify the node as part of the packet stream path. For example, where some nodes have hit counts in the thousands and other nodes have hit counts with a few hits or a few dozen hits, the analysis module 208 would not count the hits from the ACL hit counters with a few hits or a few dozen hits.

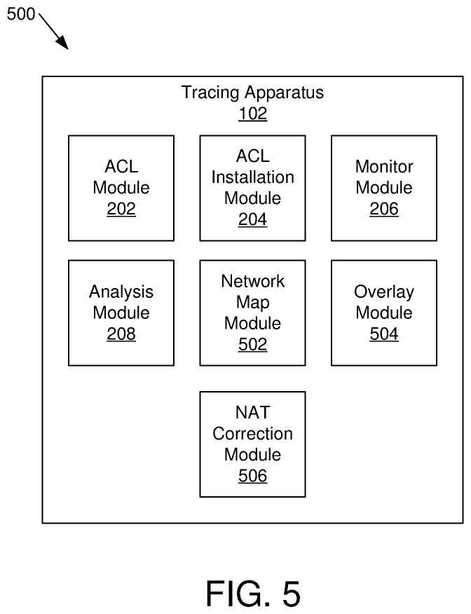

Once the analysis module 208 has identified the nodes in the network where the packet passed, in some embodiments, the analysis module 208 reports the nodes where the packet passed. In some embodiments, the analysis module 208 reports the nodes where the packet passed by transmitting a message to the user with the nodes listed where the packet passed. In other embodiments, the analysis module 208 reports the nodes where the packet passed to another module, such as the overlay module 504, which is discussed below in conjunction with FIG. 5.

FIG. 5 is a schematic block diagram illustrating another apparatus 500 for tracing a packet stream in a network using access control lists, according to various embodiments. The apparatus 500 includes another tracing apparatus 102 with an ACL module 202, an ACL installation module 204, a monitor module 206, and an analysis module 208, which are substantially similar to those described above in relation to the apparatus 200 of FIG. 2. In various embodiments, the apparatus 500 includes a network map module 502, an overlay module 504, and/or a NAT correction module 506, which are described below. In some embodiments, the apparatus 500 is implemented using executable code stored on non-transitory computer readable media. In other embodiments, all or a portion of the apparatus 500 is implemented using a programmable hardware device and/or hardware circuits.

In some embodiments, the apparatus 500 includes a network map module 502 configured to derive a network map. In some embodiments, the network map module 502 uses network information from a neighboring network protocol, such as in a Link Layer Discovery Protocol (“LLDP”) format. In other embodiments, the neighboring network protocol is in a Cisco Discovery Protocol (“CDP”) format. In some embodiments, the network map module 502 derives a diagram for display on an electronic display with the network, similar to the network diagram 100 of FIG. 1. In some embodiments, the network map module 502 uses results from another application that derives the network map. In the embodiments, the network map module 502 imports a network map. In other embodiments, the network map module 502 merely accesses the other application.

In some embodiments, the apparatus 500 includes an overlay module 504 configured to overlay a visual packet travel path 114 on the visual network diagram that includes the nodes of the network, the source computing device, and the destination computing device. The visual packet travel path 114 goes through the identified nodes where the packet stream passed. Referring back to FIG. 1, a packet travel path 114 is depicted going from Host 1 110a, to SW1A 106a, to SW2A 106b, to R1A 108a, to R4A 108d, to R5A 108e, and to the public network 112. The packet travel path 114 also includes coming from the public network 112, to R4B 108i, to R1B 108f, to SW2B 106e, to SW1B 106d, and to Host 2 110b. The overlay module 504, in some embodiments, would overlay on the network diagram a similar travel path. In other embodiments, the overlay module 504 overlays on the network diagram a packet travel path 114 in a different format.

In some embodiments, the apparatus 500 includes a NAT correction module 506 configured to replace the source address with a new source address in the ACL of nodes of the plurality of nodes replacing a source address with a new source address by way of network address translation (“NAT”) and/or downstream nodes of the plurality of nodes. As explained above, some nodes may be gateway nodes where a NAT table is used to replace a source address with a new source address to be used for all downstream nodes. In some embodiments, the NAT service records in the NAT table the source address and packet information so that when another packet responding to the packet has the new source address replaced with the original source address. In some embodiments, the source address and the new source address are IP addresses. In other embodiments, the source address and the new source address are MAC addresses.

The NAT correction module 506, in some embodiments, replaces the source address in the ACL created by the ACL module 202 with the new source address only in nodes downstream of the gateway node that is replacing the source address of packets with the new source address. In some embodiments, the ACL from the ACL module 202 is for an ingress port of the nodes. In such embodiments, a packet received by the node at the ingress port that matches the criteria of the ACL (e.g., the source address and destination address of the packet match the ACL) will trigger the ACL hit counter of the gateway node so there is no need to change the ACL of the gateway node. In other embodiments, the ACL is for an egress port of the plurality of nodes. In such embodiments, the egress port of the gateway node receives the packet with the new source address and the NAT correction module 506 replaces the ACL of the gateway node changing the source address with the new source address as well as the downstream nodes.

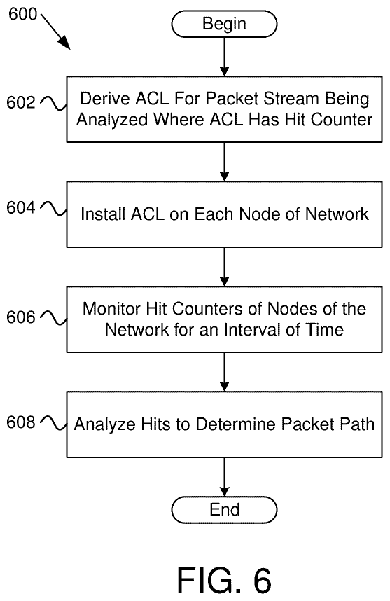

FIG. 6 is a schematic flow chart diagram illustrating a method 600 for tracing a packet stream in a network using access control lists, according to various embodiments. The method 600 begins and derives 602 an ACL for a packet stream being analyzed. The ACL includes a source address, a destination address, and enables an ACL hit counter. The method 600, in some embodiments, creates an action that enables the ACL hit counter. The ACL hit counter is triggered and increases when a packet of the packet stream is received at the node where the packet includes the source address and destination address. The ACL hit counter increases to signify that the packet from the packet stream passed through the node.

The method 600 installs 604 the ACL on each node of a plurality of nodes of the network between a computing device with the source address (e.g., Host 1 110a) and a computing device with the destination address (e.g., Host 2 110b). The method 600 monitors 606 ACL hit counters for the plurality of nodes over an interval of time and analyzes 608 a number of hits of each ACL hit counter of the nodes to identify nodes of the plurality of nodes where the packet stream passed, and the method 600 ends. Nodes with ACL hit counters registering a significant number of hits are nodes where packets of the packet stream passed. In various embodiments, all or a portion of the method 600 are implemented using the ACL module 202, the ACL installation module 204, the monitor module 206, the analysis module 208, and/or the NAT correction module 506.

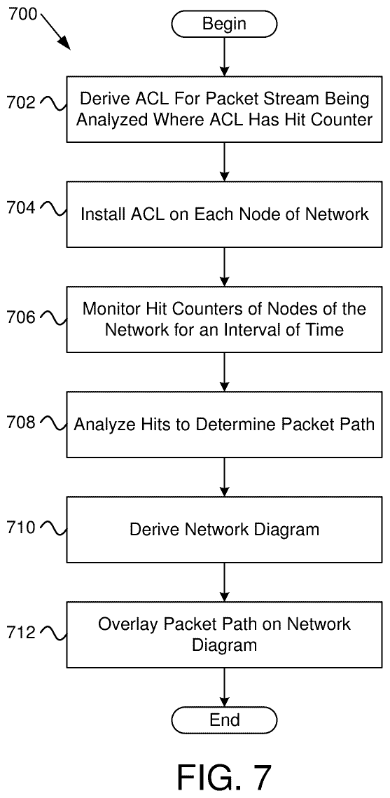

FIG. 7 is a schematic flow chart diagram illustrating another method 700 for tracing a packet stream in a network using access control lists, according to various embodiments. The method 700 begins and derives 702 an ACL for a packet stream being analyzed. The ACL includes a source address, a destination address, and enables an ACL hit counter. The method 700, in some embodiments, creates an action that enables the ACL hit counter. The ACL hit counter is triggered and increases when a packet of the packet stream is received at the node where the packet includes the source address and destination address. The ACL hit counter increases to signify that the packet from the packet stream passed through the node.

The method 700 installs 704 the ACL on each node of a plurality of nodes of the network between a computing device with the source address (e.g., Host 1 110a) and a computing device with the destination address (Host 2 110b). The method 700 monitors 706 ACL hit counters for the plurality of nodes over an interval of time and analyzes 708 a number of hits of each ACL hit counter of the nodes to identify nodes of the plurality of nodes where the packet stream passed. The method 700 derives 710 a network diagram with the nodes of the network along with the source computing device and the destination computing device. While deriving 710 the network diagram is depicted in FIG. 7 after analyzing 708 hist to determine a packet path, in other embodiments deriving 710 the network diagram occurs at some other time, such as before deriving 702 an ACL. In some embodiments, the method 700 uses LLDP and/or CDP to derive the network diagram. In some embodiments, the network diagram is displayable on an electronic display. The method 700 overlays 712 a visual packet travel path 114 on the network diagram, and the method 700 ends. The packet travel path 114 goes through the identified nodes where the packet stream passed. In various embodiments, all or a portion of the method 700 are implemented using the ACL module 202, the ACL installation module 204, the monitor module 206, the analysis module 208, the NAT correction module 506, the network map module 502, and/or the overlay module 504.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
deriving an access control list (“ACL”) for a packet stream being analyzed, the ACL comprises a source address, a destination address, and enables an ACL hit counter;
installing the ACL on each node of a plurality of nodes of a network between a computing device with the source address and a computing device with the destination address, wherein an ACL hit counter of a node of the plurality of nodes increases for each packet of the packet stream that passes through the node and matches the ACL;
monitoring the ACL hit counters for the plurality of nodes over an interval of time; and
analyzing a number of hits of each ACL hit counter of the nodes to identify nodes of the plurality of nodes where the packet stream passed.

2. The method of claim 1, further comprising overlaying a visual packet travel path on a visual network diagram comprising the nodes of the network, the source computing device, and the destination computing device, the visual packet travel path intersecting the identified nodes where the packet stream passed.

3. The method of claim 2, further comprising deriving the network diagram.

4. The method of claim 3, wherein deriving the network diagram comprises using network information from a neighboring network protocol.

5. The method of claim 1, further comprising replacing the source address with a new source address in the ACL of gateway nodes of the plurality of nodes replacing a source address with a new source address by way of network address translation (“NAT”) and/or nodes of the plurality of nodes downstream of the gateway nodes.

6. The method of claim 1, wherein the source address comprises a source media access control (“MAC”) address and/or a source internet protocol (“IP”) address and the destination address comprises a destination MAC address and/or a destination IP address.

7. The method of claim 1, wherein the ACL comprises an action compatible with other ACLs installed at the plurality of nodes.

8. The method of claim 1, wherein the network comprises a private network and wherein the packet stream travels from the private network to a public network and back to the private network, wherein the ACL is installed on the nodes of the private network.

9. The method of claim 1, wherein the ACL further comprises a protocol type, an action, and/or an enablement of the ACL hit counter.

10. The method of claim 1, wherein the ACL is for an ingress port of a node and/or an egress port of the node.

11. An apparatus comprising:
a processor; and
non-transitory computer readable storage media storing code, the code being executable by the processor to perform operations comprising:
deriving an access control list (“ACL”) for a packet stream being analyzed, the ACL comprises a source address, a destination address, and enables an ACL hit counter;
installing the ACL on each node of a plurality of nodes of a network between a computing device with the source address and a computing device with the destination address, wherein an ACL hit counter of a node of the plurality of nodes increases for each packet of the packet stream that passes through the node and matches the ACL;
monitoring the ACL hit counters for the plurality of nodes over an interval of time; and
analyzing a number of hits of each ACL hit counter of the nodes to identify nodes of the plurality of nodes where the packet stream passed.

12. The apparatus of claim 11, wherein the operations further comprise overlaying a visual packet travel path on a visual network diagram comprising the nodes of the network and/or the source computing device and the destination computing device, the visual packet travel path intersecting the identified nodes where the packet stream passed.

13. The apparatus of claim 12, further comprising deriving the network diagram using network information from Link Layer Discovery Protocol (“LLDP”) and/or Cisco Discovery Protocol (“CDP”).

14. The apparatus of claim 11, wherein the operations further comprise replacing the source address with a new source address in the ACL of gateway nodes of the plurality of nodes replacing a source address with a new source address by way of network address translation (“NAT”) and/or nodes of the plurality of nodes downstream of the gateway nodes.

15. The apparatus of claim 11, wherein the source address comprises a source media access control (“MAC”) address and/or a source internet protocol (“IP”) address and the destination address comprises a destination MAC address and/or a destination IP address.

16. The apparatus of claim 11, wherein the processor is part of a network controller in communication with each of the plurality of nodes of the network.

17. The apparatus of claim 11, wherein the network comprises a private network and wherein the packet stream travels from the private network to a public network and back to the private network, wherein the ACL is installed on the nodes of the private network.

18. The apparatus of claim 11, wherein each node of the plurality of nodes comprises one of a switch and a router.

19. The apparatus of claim 11, wherein the ACL is for an ingress port of a node and/or an egress port of the node.

20. A system comprising:
a plurality of nodes of a network; and
a network controller comprising:
a processor; and
non-transitory computer readable storage media storing code, the code being executable by the processor to perform operations comprising:
deriving an access control list (“ACL”) for a packet stream being analyzed, the ACL comprises a source address, a destination address, and enables an ACL hit counter;
installing the ACL on each node of the plurality of nodes of the network between a computing device with the source address and a computing device with the destination address, wherein an ACL hit counter of a node of the plurality of nodes increases for each packet of the packet stream that passes through the node and matches the ACL;
monitoring the ACL hit counters for the plurality of nodes over an interval of time; and
analyzing a number of hits of each ACL hit counter of the nodes to identify nodes of the plurality of nodes where the packet stream passed.
